(19) United States
(12) Patent Application Publication
(10) Pub. No.: US 2005/0021416 A1
(43) Pub. Date: Jan. 27, 2005

(54) Method and apparatus for third party bidding in sales transactions

(76) Inventors: Glen J. Anderson, Sioux City, IA (US); Russell F. McKnight, Sioux City, IA (US)

Correspondence Address: GATEWAY, INC.;ATTN: SCOTT CHARLES RICHARDSON, 610 GATEWAY DRIVE, MAIL DROP Y-04, N. SIOUX CITY, SD, 57049, US

(21) Appl. No.: 10/625,252

(22) Filed: Jul. 23, 2003

(51) Int. Cl. G06F 17/60

(52) U.S. Cl. 705/26

(57) ABSTRACT

Third parties are alerted to a sales transaction between a seller and a customer for the purchase of a product. A bidding process is established for one or more real-time marketing opportunities associated with the transaction to provide one or more of a peripheral, a promotion, a download, and an offer.

### FIELD OF THE INVENTION

The present invention generally relates to computerized transactions. In particular, the present invention relates to third party bidding for promotional and advertising-related opportunities associated with a sales transaction.

### BACKGROUND OF THE INVENTION

Modem computer retailers, particularly those operating with a retail and/or an Internet-based e-commerce presence, engage in thousands of transactions per day. Such transactions involve inquiries by customers, new orders for one or more computers, repeat orders for one or more computers, new or repeat orders for accessories, and the like. In the process of handling such orders, information is gathered and stored related to customers including credit card information, certain demographic information such as income, residence location, and the like. Such information could be useful in determining whether such customers may be interested in information from third parties and further whether such customers meet the demographic criteria for purchase of the product or possess related qualifications.

Problems arise however, in that for business-related and privacy-related confidentiality reasons there is usually a large disconnect between an individual merchant or retailer's customer information and access to such information by third parties. Further, merchants or retailers and even customers often fail to receive preferential rates or special promotional offers because customer demographic information and order quantity information by demographic is not readily available to third parties particularly at the time of an individual transaction.

Still other problems arise associated with what price to charge vendors or associated third parties for opportunities to submit offers or promotions which may then be bundled with products sales. For example, a “free” or discounted printer might be included with a computer system sale. The opportunity to be included in such an offer space is a valuable one which should be offered at the correct price to competing third parties.

Some systems attempt to access detailed customer information at the point-of-sale in order to provide special offers or the like. Such a system is described in U.S. Pat. No. 6,401,074 issued on Jun. 4, 2002 to Sleeper. Therein, a system is described for providing promotional information during a retail transaction at the point-of-sale to customers based on certain contexts such as customer loyalty or the like. Although promotional information may be provided to a customer in a “real-time” manner, the promotional information typically relates to specials or discounts associated with the next shopping event.

Other systems such as that described in U.S. Pat. No. 6,341,270 issued on Jan. 22, 2002 to Esposito et. al, attempt to refine the quality of customer demographic and purchase preference information by allowing vendors to “purchase” notifications associated with customer inquiries for products. The price payable for such a notification is set by transmitting to vendors an initial notification purchase price. As time passes, the price of the notification is automatically reduced. A purchase request message is sent from a purchasing vendor at a desired price. The successful purchasing vendor then receives the customer purchase information.

For setting the correct price for sale, on-line auctions are emerging as a popular way to get the best price for anything from memorabilia to automobiles, computers, and even real estate or the like. Combined with “push” processing of, for example, bid closing information to participating bidders, the number of final bids may be increased and, hopefully, the final price of an item. Such a system is described in International Publication WO 02/27517 A1 filed Sep. 28, 2001 by Garfinkle et. al. Beyond public auctions conducted on-line, businesses are also recognizing that auctions are an efficient way to set prices for business transactions.

Typically, such auction systems are used in a conventional manner, that is, a “seller” lists an opening price for an item for auction, a term for expiration of the auction, and in some cases a reservation price, e.g. the minimum acceptable price for the item. In other instances, sellers market directly through the auction site for products of which many are available at a set price. Minimal information is available about the buyer in terms of qualifications for purchase and, in any case, no opportunities are available for third parties in an interactive manner.

For businesses, securing the best price from vendors may be achieved in a reverse auction. In reverse auction scenarios, the buying price preferably decreases resulting in the best price for a good or service sought by a buyer. Reverse auctions are further described in a document entitled: “e-Auctions Beyond Cost-cutting: Harnessing the Potential of e-Auctions as a Purchase and Negotiating Tool” by David Longworth, Dennis Howlett & Keith Rodgers of Webster Buchannan Research in association with GE Global exchange Services (hereinafter “e-Auctions”). Notably absent from the reverse auction scenario described in e-Auctions is an end user or customer transaction.

Consequently, it would be desirable to provide an ability for third parties to bid on opportunities to include their products, promotions, and/or software downloads in connection with end user or customer sales transactions.

### SUMMARY OF THE INVENTION

Accordingly, the present invention is directed to a method for providing one or more real-time marketing opportunities to one or more third parties during a sales transaction between a customer and a seller for the purchase of a product, the real-time marketing opportunity being offered by the seller. The “product,” as this term is used in the present disclosure, may include goods (e.g., golf clubs) or services (e.g., golf lessons).

In one exemplary embodiment, a communication connection may be established between the seller and one or more third parties. An alert may then be issued over the established connection to the third parties, the alert indicating that the sales transaction is in progress and a bidding process is open for bidding. Bidding may be conducted on at least one of the real-time marketing opportunities. A time duration may be established, e.g. a clock may be started or a period for bidding otherwise set, for the bidding process associated with the real-time marketing opportunity. One or more bids may be received from third parties for the real-time marketing opportunity preferably indicating the price the third party is willing to pay for the opportunity. Alternatively, the bid may include the price for the real-time marketing opportunity, and the price for the item offered.

In another exemplary embodiment, an end-of-bidding alert may be issued to the third parties that a winning bid has been received. The transaction may then be completed between the seller and the customer for the product including the marketing opportunity. It should be noted that the one or more real-time marketing opportunities may preferably include an opportunity to provide one or more of: a peripheral, such as a printer, multimedia speakers, a sound card; a promotion, such as free connectivity from a service provider; a download, such as a software download or the like, or any other type of offer or the like, to be included in the transaction for the purchase of the product.

In still another exemplary embodiment, general information associated with the one or more real-time marketing opportunities may be offered on an Internet site associated with the seller. Accordingly, third parties may be allowed to establish a communication connection with the seller over the Internet site.

In accordance with still other exemplary embodiments, an apparatus and article of manufacture provide one or more real-time marketing opportunities to third parties during a sales transaction between a customer and a seller for the purchase of a product, the real-time marketing opportunity being offered by the seller. The apparatus may preferably include a network, and a processor coupled to the network. The article of manufacture may preferably include a computer readable medium such as a disk, e.g. a CD ROM disk, a floppy disk or the like, or even a signal, e.g. a communication signal read over a connection such as a network connection. The process may be configured or otherwise caused by the instructions read from the computer readable medium to: establish a communication connection between the seller and the third parties over the network, issue an alert over the established connection to the third parties that the sales transaction is in progress and a bidding process is open for bidding on the real-time marketing opportunities, establish a time duration for the bidding process, and receive one or more bids from the third parties for the real-time marketing opportunity. The processor may further be configured or otherwise caused by the instructions read from the computer readable medium to: issue an end-of-bidding alert to the third parties that a winning bid has been received, and complete the transaction between the seller and the customer for the product including the marketing opportunity. It should be noted that the one or more real-time marketing opportunities may preferably include an opportunity to provide one or more of: a peripheral, such as a printer, multimedia speakers, a sound card; a promotion, such as free connectivity from a service provider; a download, such as a software download or the like, or any other type of offer or the like, to be included in the transaction for the purchase of the product.

In accordance with still another exemplary embodiment of the present invention, the processor in establishing a communication connection may further be configured or otherwise caused by the instruction read from the computer readable medium to: offer general information associated with the real-time marketing opportunities on an Internet site associated with the seller, and allow the third parties to establish a communication connection with the seller over the Internet site.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1A is a diagram illustrating an exemplary third party bidding system in accordance with various exemplary embodiments of the present invention;

FIG. 1B is a flow chart illustrating steps in an exemplary third party bidding system in accordance with various exemplary embodiments of the present invention;

FIG. 2A is a diagram illustrating an exemplary third party bidding scenario in accordance with various exemplary embodiments of the present invention;

FIG. 2B is a diagram further illustrating an exemplary third party bidding scenario in accordance with various exemplary embodiments of the present invention;

FIG. 2C is a diagram further illustrating an exemplary third party bidding scenario in accordance with various exemplary embodiments of the present invention;

FIG. 3 is diagram illustrating an exemplary completed sales transaction including exemplary third party bidding winners in accordance with various exemplary embodiments of the present invention;

FIG. 4 is a diagram illustrating an exemplary software download opportunity in accordance with various exemplary embodiments of the present invention; and

FIG. 5 is a flow chart illustrating steps in an exemplary third party bidding system in accordance with various exemplary embodiments of the present invention

### DETAILED DESCRIPTION OF THE INVENTION

The present invention provides third parties with a method to bid on marketing opportunities which arise in the course of a sales transaction, e.g. a transaction between a qualified customer and a retailer for, for example, a computer system. Reference will now be made in detail to the presently preferred embodiments of the invention, examples of which are illustrated in the accompanying drawings.

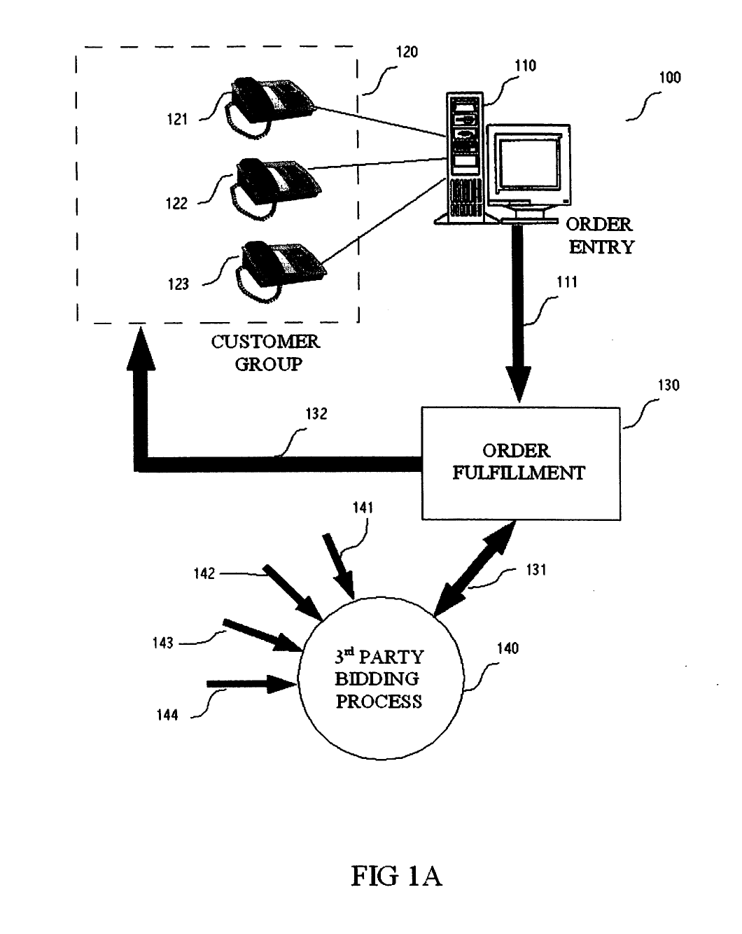

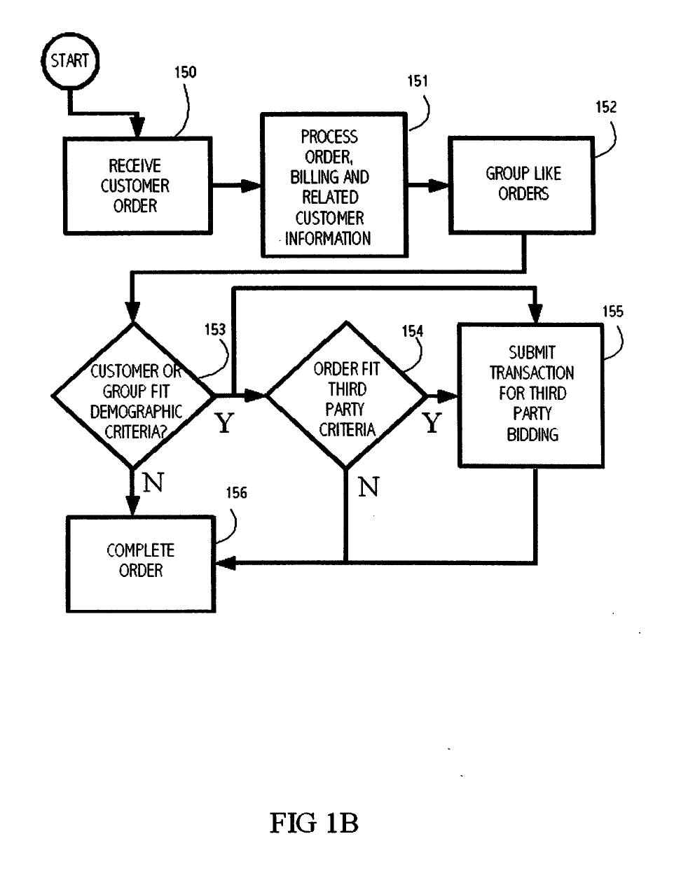

In FIG. 1A, scenario 100 is shown including order entry system 110 for taking orders from customers 121, 122, and 123, for example, which may further be part of qualified customer group 120. It will be appreciated that customer group 120 may include customers fitting certain exemplary demographic profiles including but not limited to income, age, sex, and the like, which profiles may be gathered during, or before, order taking and transaction processing. Profiles may also exist before the transaction, e.g., when selling to a registered install base, thus allowing bidding previous to a transaction. Once initial order entry processing is performed and customer profiles are built to form customer group 120, order information 111, which may include customer information, order information, and information related to third party promotions, offers, downloads, and the like, may be sent to order fulfillment process 130 including a method for including winning third-party offers, promotions and the like into the deliverable system. Therein, alert 131 which may include offers for inclusion in the present transaction may be sent for automated bid solicitation in exemplary third party bidding process 140 where third parties 141-144 may respond to alert 131 with corresponding bids for inclusion in the transaction.

In accordance with various exemplary embodiments of the present invention, the method for allowing third parties to bid on opportunities to be included in sales transactions generally proceeds according to the exemplary steps illustrated in FIG. 1B as follows. After the customer order is received in step 150, the order may be processed including the collection of customer information such as billing information, demographic information, system information, information related to request for peripherals such as printers, multimedia speakers or the like. Such information may be used to group orders, as in step 152, into customer groups such as those customers wanting printers, or those customers wanting printers who have also purchased a digital camera, or the like, so that, for example in the case of the customers who have purchased a digital camera, a more capable printer such as a color printer may be offered. If the customer information indicates that a particular demographic criteria is met, as in decision step 153, the order may be passed to decision 154, where a further, optional determination may be made regarding whether the order information fits third party criteria associated with offers or promotions which the third party wishes to make available to customers with the particular criteria. If the criteria are met in either or both of steps 153 and 154, the order may be submitted for third party bidding in step 155 as will be described in greater detail hereinafter, whereupon once third party bid winners are determined or in the absence of third party bidding, the order may be fulfilled in step 156. In some embodiments vendors may bid on access to a predetermined number of sales seats (e.g., customer service representatives or technical service representatives interfacing with customers), or even predetermined individuals or groups of individuals manning the sales seats who have experience with a certain product or are particularly effective at making sales and interfacing with customers. In some embodiments vendors may bid on access to predetermined times, that is predetermined times of the day, times of the month, times during the season (e.g., certain days or weeks before the Christmas sales season). In some embodiments vendors may bid on access to customers in a targeted category, e.g., customers from predetermined telephone area codes, customers who have purchased certain products in the past or are served by a given competitor, or customers with a known problem or need. In some embodiments vendors may bid to have their products featured if, during the course if interacting with a customer, a predetermined or certain “keyword” is mentioned. For example, if the customer mentions cameras then the winning camera vendor's may appear at the top of the sales person's list. The keyword may be entered by the sales person or detected using known methods of speech recognition.

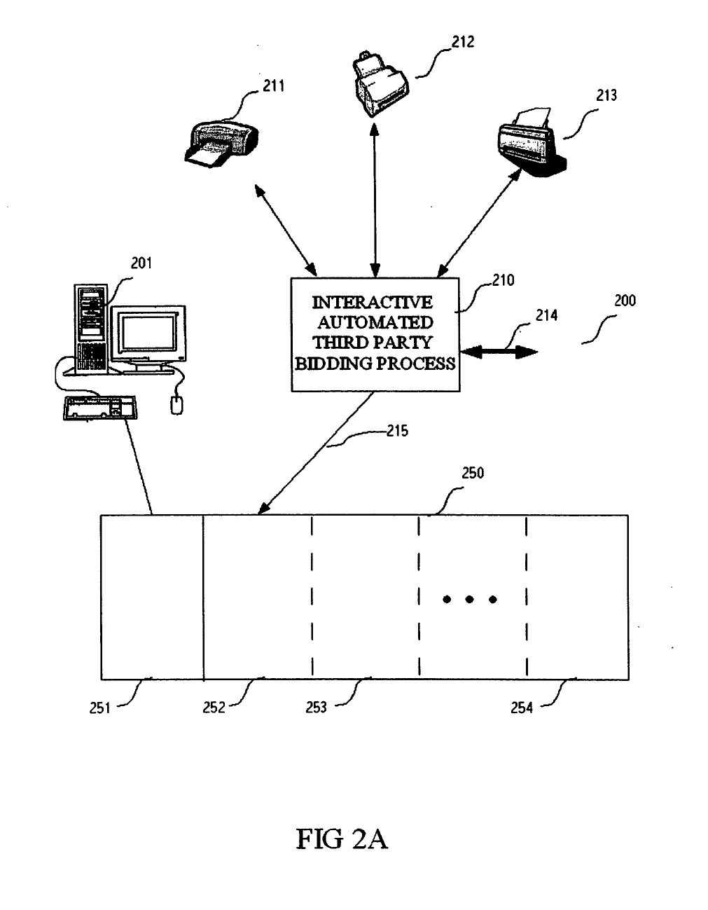

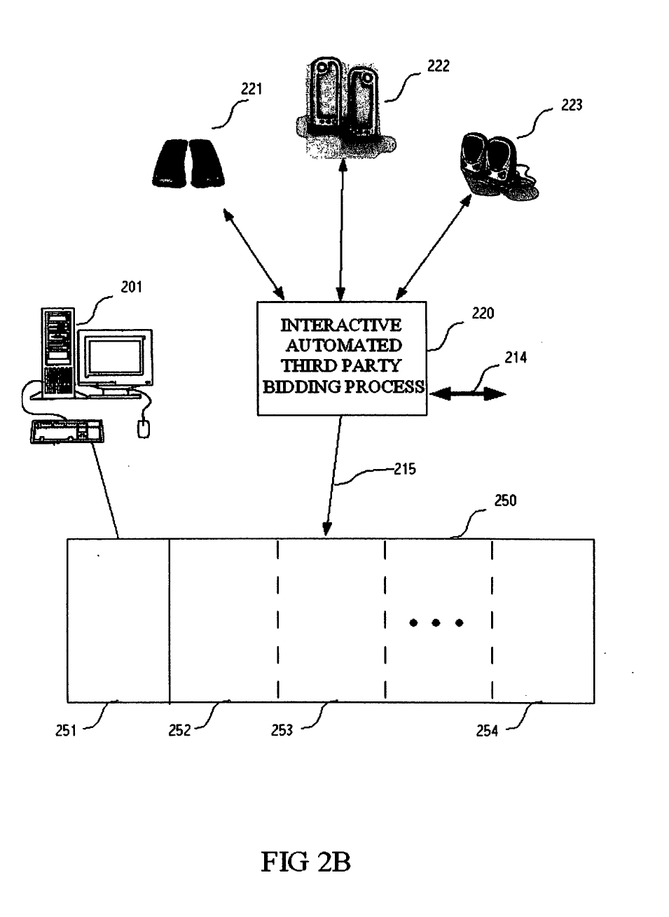

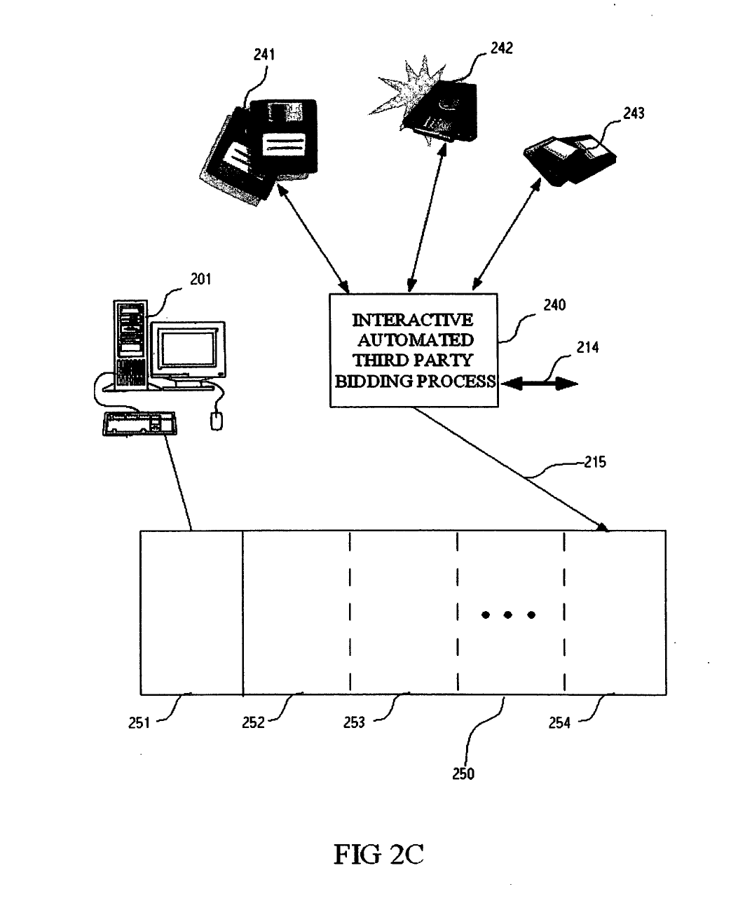

Elements of an exemplary third party bidding process 200 for an opportunity to supply a printer in the transaction associated with computer system 201 are shown in FIG. 2A. Therein, different third parties or vendors may have an opportunity through interactive automated third party bidding process 210 to provide their respective printers 211, 212, and 213 in one of opportunity “slots” 251, 252, 253, 254 or the like of system deliver package 250, which may be a Bill of Materials (BOM) or the like, for delivery with computer system 201 at the conclusion of the bidding process and subsequent order fulfillment. As previously described, an alert may be issued on line 214 that, for example, a printer is being offered with system 201 at which time printer vendors associated with printers 211-213 may either agree to offer the printer at the price proffered by the system seller or may lower the price in an attempt to “win” the bid. Line 214 may be a hardware or software or even a wireless communication connection with third parties who may be either connected directly to a host system on the other end of line 214 or remote systems. It will be appreciated that the host system may preferably be associated with, for example, order entry system 110 or a larger related system having additional pricing and vendor qualification information. Accordingly, the winning third party or vendor may be approved via message 215 or the like, for having the winning product included in slot 252 associated with the printer slot to be included in delivery of computer system 201. It will be appreciated that although the number of third party printer vendors is shown for illustrative purposes to be three, greater or fewer vendors for any opportunity slot may be present with obvious advantages associated with a greater number of vendors competing to supply hardware, software, offers, promotions, or the like, at what is preferably a progressively lower price through the operation of the method of the present invention.

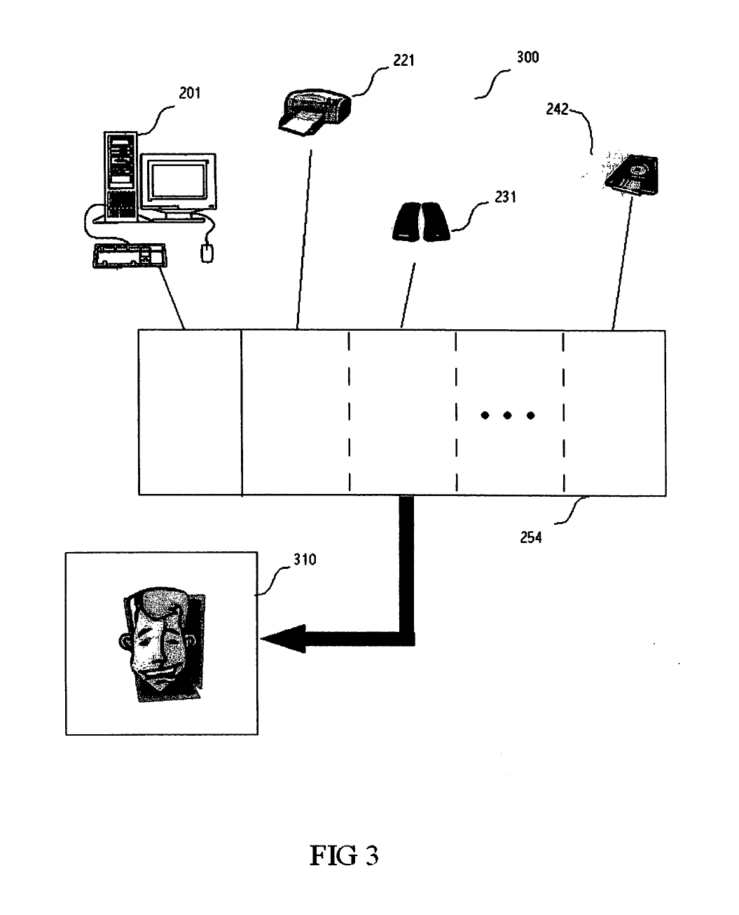

Additional opportunity slots may be set aside or allocated in one of several manners to be described in greater detail hereinafter to include additional peripherals, as shown in FIG. 2B. Speaker systems 221, 222, or 223 from different respective third parties or vendors may be included in slot 253 depending on success in interactive automated third party bidding process 220. As described, an alert may be issued on line 214 indicating that, for example, speakers are being offered or are otherwise required from the third party to be included with system 201 at which time speaker vendors associated with speakers 221-223 may either agree to offer the speakers at the price proffered by the system seller or may lower the price in an attempt to “win” the bid. Additional slots may be used for additional hardware, software, or promotional offers such as free connection time with an on-line service provider, or special prices for on-line downloads or the like. FIG. 2C illustrates interactive automated third party bidding process 240 as applied to the provision of software from different third parties or vendors. Software packages 241, 242, or 243 may be associated with, for example, a software game, an imaging program or the like provided with computer system 201. It will be appreciated that in many cases, S such as operating systems, software is bundled with system 201 with the provisioning and licensing arrangements negotiated in advance. As described, an alert may be issued on line 214 that, for example, a imaging program is being offered or is otherwise required from a third party to be included with system 201 at which time software vendors associated with software packages 241-243 may either agree to offer the software at the price proffered by the system seller or may lower the price in an attempt to “win” the bid. As shown in FIG. 3, winning scenario 300 is illustrated wherein winning third party products 221, 231, and 241 are included with system 201 which may then be delivered to customer 310.

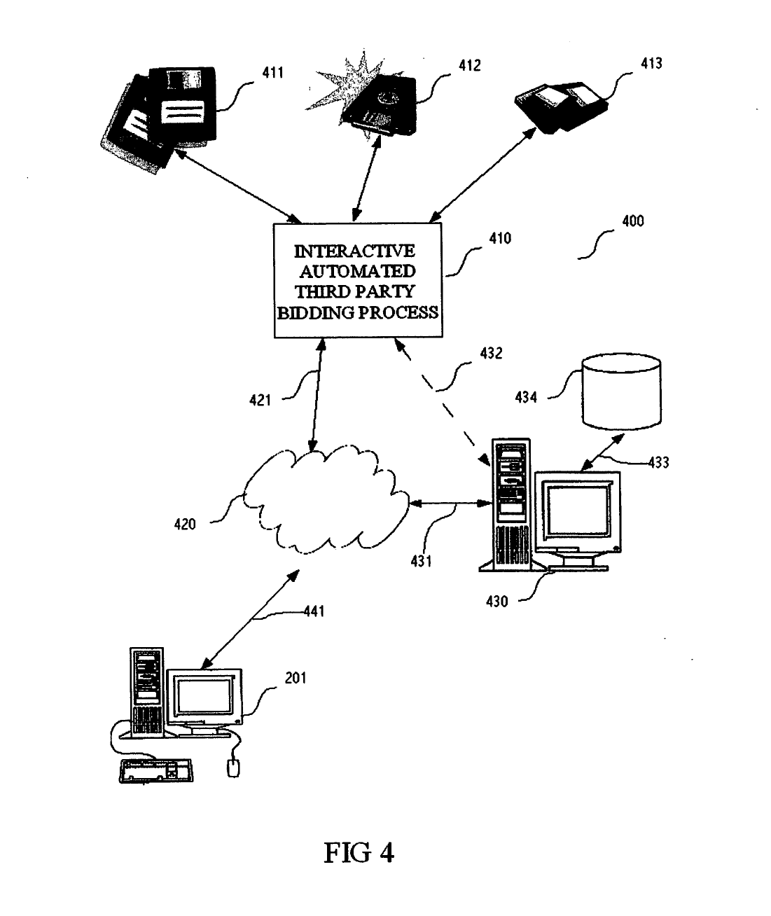

In accordance with alternative exemplary embodiments, as shown in FIG. 4 Software download opportunities may be bid for during the transaction associated with the purchase of system 201. In accordance with various alternative exemplary embodiments of the present invention, opportunities to provide software downloads may be bid for in interactive automated third party bidding process 410. The download may include as much as an entire system download, including an Operating System (OS). For a download of an entire system, just the basic connectivity software would be need to connect to the Internet, or other network. Downloads 411, 412, and 413 may be offered by associated software vendors to be obtained once the system buyer has, for example, connected to the Internet through an Internet Service Provider (ISP) or the like, or alternatively ISPs themselves may comprise the software vendors. Accordingly, system 201 may connect through line 441 which, as will be appreciated by one skilled in the art, may be a dial-up connection, a DSL connection, a cable modem connection or the like to an ISP, with cloud 420 representing one of many possible connection protocols or the like associated with line 441. Thus, system 291 may connect directly to the winning vendor via line 421 or alternatively may connect to the seller through connection 431 who may have the winning vendor's download software available by previously loading it through line 432 or line 431 through a network connection, and may store the download on storage device 434 which may be accessed through line 433 which may be a bus, serial connection, or other suitable connection.

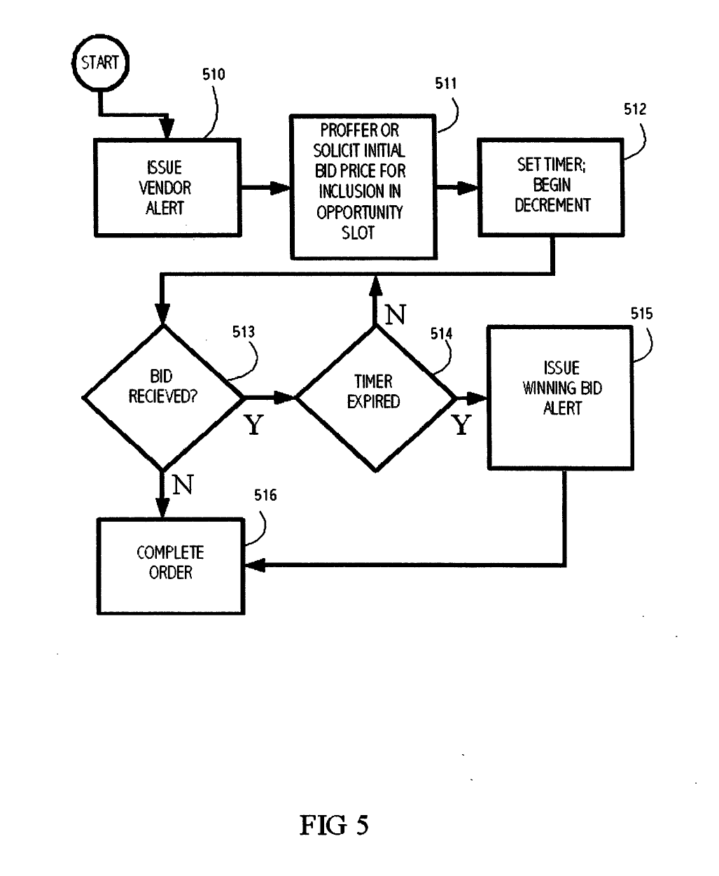

To better understand the present invention, a flowchart is illustrated in FIG.5 having steps in accordance therewith. In step 510, when a qualified buyer is placing an order for, for example a computer system, a vendor alert may be issued through one or more of several means available such as an email message to a purchasing agent or group within the vendor business, an electronic message sent from a software application running on the system seller's main computer to a complimentary software application running on the vendor's main computer, or other means as would be well known to one of skill in the art allowing the vendor to bid for an opportunity to provide the vendor's product along with the computer system being ordered. It will be appreciated that in accordance with the present invention, a dedicated software application may be established between the system seller and various vendors for products so that real time bidding can be conducted at the point of sale or in real time concurrent with the transaction.

In accordance with various alternative exemplary embodiments, the price of the opportunity and the price of the actual peripheral, promotion, offer, or the like may be negotiated and bid separately. For example, a contract between the seller and various third parties may be established to provide items at a pre-arranged price. The bidding process would therefore be invoked to determine the price paid to the seller to allow the third party to provide the item at the agreed upon price. Alternatively, the price of the opportunity and the price of the item may be bid for simultaneously or in separate sessions.

Once the alert has been issued, a solicitation for an opening bid, or a proffer of an opening price may be made in step 511. It should be noted that in the case of a proffer, the last price obtained from a respective vendor for the respective marketing opportunity might be used as the proffer price. In the event that there is no initial bid made in response to the solicitation or proffer, the system seller may revert to the standard price based on existing supply contracts with qualified vendors, or may even raise the price to stimulate an initial bid although raising the price would be undesirable and most likely unnecessary.

Once the initial price has been proffered or solicited, a timer may be set for establishing the duration of the bidding process. This may be anywhere from one to several minutes, but is preferably as short as is practical since the bidding is contemplated to occur during the conducting of the sales transaction. It will be appreciated that for vendors who are connected with the computer seller, the time for bidding on the opportunity may be greatly reduced. It will further be appreciated that extensive use of Business to Business (B2B) models using, for example, Internet connections would facilitate the participation of as many vendors as possible. The computer seller could offer general information about various real-time marketing opportunities available to be provided with sales transactions so that potential vendors could decide whether to connect to be alerted for and to provide bid information associated with one or more of the real-time marketing opportunities. Further, rather than having individual vendors running software applications, vendors could connect in an ad-hoc fashion through the Internet site sponsored by the computer seller in which to conduct bidding in accordance with the present invention.

As the time is decrementing, decision block 513 will query whether bids have been received. If so, a check will be made in decision block 514 whether there is sufficient time to process the bid, whereupon timely bids will be processed and the winning bid determined. It will further be appreciated that subsequent alerts may be issued in the form of, for example, an in-process alert or the like, such that new bidders will be informed of the current winning bid, and any other suitable information. When the timer expires, an end-of-bidding alert with winning bid information may be issued in block 515 to end the bidding process. Once the bidding process has ended and the price for the marketing opportunity along with the and the order completed in block 516.

It is believed that the third party bidding method of the present invention and many of its attendant advantages will be understood by the forgoing description. It is also believed that it will be apparent that various changes may be made in the form, construction and arrangement of the steps thereof without departing from the scope and spirit of the invention or without sacrificing all of its material advantages. The form herein before described being merely an explanatory embodiment thereof. It is the intention of the following claims to encompass and include such changes.

1. A method for providing one or more real-time marketing opportunities to one or more third parties during a sales transaction between a customer and a seller for purchasing a product, the real-time marketing opportunity being offered by the seller, the method comprising:
establishing a communication connection between the seller and the one or more third parties;
issuing an alert over the established connection to the one or more third parties that the sales transaction is in progress and a bidding process is open for soliciting one or more bids on at least one of the one or more real-time marketing opportunities;
establishing a time duration for the bidding process associated with the at least one real-time marketing opportunity; and
receiving the one or more bids from the one or more third parties for the at least one real-time marketing opportunity.

2. The method of claim 1, further comprising the steps of:
issuing an end-of-bidding alert to the one or more third parties that a winning bid has been received; and
completing the transaction between the seller and the customer for the product including the at least one marketing opportunity.

3. The method of claim 1, wherein the one or more real-time marketing opportunities include an opportunity to provide one or more of: a peripheral, a promotion, a download, and an offer, to be included in the transaction for the purchase of the product.

4. The method of claim 2, wherein the one or more real-time marketing opportunities include an opportunity to provide one or more of a group consisting of a peripheral, a promotion, a download, and an offer, to be included in the transaction for the purchase of the product.

5. The method of claim 1, wherein the step of establishing a communication connection further includes:
offering general information associated with the one or more real-time marketing opportunities on an Internet site associated with the seller, and
allowing the one or more third parties to establish a communication connection with the seller over the Internet site.

6. The method of claim 1, wherein the step of establishing a communication connection further includes:
offering general information associated with the one or more real-time marketing opportunities via a telephone conversation with the seller; and
allowing the one or more third parties to establish a communication connection with the seller over the Internet site.

7. An apparatus for providing one or more real-time marketing opportunities to one or more third parties during a sales transaction between a customer and a seller for purchasing a product, the real-time marketing opportunity being offered by the seller, the apparatus comprising:
a network; and
a processor coupled to the network, the processor configured to:
establish a communication connection between the seller and the one or more third parties over the network;
issue an alert over the established connection to the one or more third parties that the sales transaction is in progress and a bidding process is open for bidding on at least one of the one or more real-time marketing opportunities;
establish a time duration for the bidding process associated with the at least one real-time marketing opportunity; and
receive one or more bids from the one or more third parties for the at least one real-time marketing opportunity.

8. The apparatus of claim 7, wherein the processor is further configured to:
issue an end-of-bidding alert to the one or more third parties that a winning bid has been received; and
complete the transaction between the seller and the customer for the product including the at least one marketing opportunity.

9. The apparatus of claim 7, wherein the one or more real-time marketing opportunities include an opportunity to provide one or more of a group consisting of a peripheral, a promotion, a download, and an offer, to be included in the transaction for the purchase of the product.

10. The apparatus of claim 8, wherein the one or more real-time marketing opportunities include an opportunity to provide one or more of a group consisting of a peripheral, a promotion, a download, and an offer, to be included in the transaction for the purchase of the product.

11. The apparatus of claim 7, wherein the processor in establishing a communication connection is further configured to:
offer general information associated with the one or more real-time marketing opportunities on an Internet site associated with the seller; and
allow the one or more third parties to establish a communication connection with the seller over the Internet site.

12. The apparatus of claim 7, wherein the processor in establishing a communication connection is further configured to:
offer general information associated with the one or more real-time marketing opportunities via a telephone conversation with the seller; and
allow the one or more third parties to establish a communication connection with the seller over the Internet site.

13. An article of manufacture for providing one or more real-time marketing opportunities to one or more third parties during a sales transaction between a customer and a seller for purchasing a product, the real-time marketing opportunity being offered by the seller, the article of manufacture comprising:
a computer readable medium; and
instructions carried on the computer readable medium, the instructions readable by a processor, the instructions for causing a processor to:
establish a communication connection between the seller and the one or more third parties over a network;
issue an alert over the established connection to the one or more third parties that the sales transaction is in progress and a bidding process is open for bidding on at least one of the one or more real-time marketing opportunities;
establish a time duration for the bidding process associated with the at least one real-time marketing opportunity; and
receive one or more bids from the one or more third parties for the at least one real-time marketing opportunity.

14. The article of manufacture of claim 13, wherein the instruction further cause the processor to:
issue an end-of-bidding alert to the one or more third parties that a winning bid has been received; and
complete the transaction between the seller and the customer for the product including the at least one marketing opportunity.

15. The article of manufacture of claim 13, wherein the one or more real-time marketing opportunities include an opportunity to provide one or more of a group consisting of a peripheral, a promotion, a download, and an offer, to be included in the transaction for the purchase of the product.

16. The article of manufacture of claim 14, wherein the one or more real-time marketing opportunities include an opportunity to provide one or more of a group consisting of a peripheral, a promotion, a download, and an offer, to be included in the transaction for the purchase of the product.

17. The article of manufacture of claim 13, wherein the instructions in causing the processor to establish a communication connection further cause the processor to:
offer general information associated with the one or more real-time marketing opportunities on an Internet site associated with the seller; and
allow the one or more third parties to establish a communication connection with the seller over the Internet site.

18. The article of manufacture of claim 13, wherein the instructions in causing the processor to establish a communication connection further cause the processor to:
offer general information associated with the one or more real-time marketing opportunities via a telephone conversation with the seller; and
allow the one or more third parties to establish a communication connection with the seller over the Internet site.
